(19) United States
(12) Patent Application Publication
(10) Pub. No.: US 2019/0355204 A1
(43) Pub. Date: Nov. 21, 2019

(54) POINT OF PURCHASE HYBRID GAMING SYSTEM

(71) Applicant: State of Arizona, Arizona Lottery, Phoenix, AZ (US)

(72) Inventors: Gregory Ross Edgar, Phoenix, AZ (US); Ivy Fern Gilio, Phoenix, AZ (US); Biju Kamal Kamaleswaran, Phoenix, AZ (US); Christopher Thomas Rogers, Phoenix, AZ (US); Kimberly Ann Siddall, Phoenix, AZ (US); Sherri Lynne Zendri, Phoenix, AZ (US); James M. Stipe, Phoenix, AZ (US); Raynie Hosto, Phoenix, AZ (US)

(73) Assignee: State of Arizona, Arizona Lottery, Phoenix, AZ (US)

(21) Appl. No.: 16/417,466

(22) Filed: May 20, 2019

Related U.S. Application Data
(60) Provisional application No. 62/673,848, filed on May 18, 2018.

(51) Int. Cl. G07F 17/32; G06Q 20/28

(52) U.S. Cl. CPC G07F 17/329; G06Q 20/28; G07F 17/3241

(57) ABSTRACT

There is provided a system and method for an alternative and improved game of chance, and an infrastructure to allow customer-originated purchases of games of chance and recordation and authentication of a bearer instrument. In one embodiment, this invention provides the ability to purchase pre-selected randomly generated numbers for games in any common customer areas or checkout lines at authorized retailers. Enhanced gaming options such as parlay and multi-game options are also provided.

### CROSS REFERENCE TO RELATED APPLICATIONS

This application is related to, and claims priority from U.S. provisional patent application No. 62/673,848, filed on May 18, 2018 name and titled “POINT OF PURCHASE HYBRID GAMING SYSTEM,” the disclosures of which are hereby fully incorporated by reference for all purposes.

### BACKGROUND OF THE INVENTION

### Field of the Invention

The present invention relates to gaming systems such as lotteries, and more particularly, to the provision and sale of a gaming systems and methods for the use of a hybrid gaming system utilizing a pre-configured lottery game card.

### Description of the Related Art

Games of chance have evolved over thousands of years to provide many forms of risk-based entertainment (and for the gaming host agency, income). While many examples of games exist where players participate in a chance-based wagering of money on a particular outcome, lotteries have grown to provide not only an affordable gaming experience, but a venue to provide customers with the opportunity to participate in potentially large prize pools. As a beneficial side effect, state-sponsored lotteries (or other governmental or private gaming host agencies) may be utilized to obtain additional sources of revenue to fund critical projects or provide for services such as education and other community benefits. Conventional lottery-based games generally fall into one of two main categories:

1. Draw Games

A player selects a specific and predefined quantity of numbers from a specified pool ahead of a drawing. At the time of the drawing, the game-provider (such as a lottery organization) randomly draws an official combination of the amount of numbers from the pool. Players must match the numbers as specified by a predetermined set of rules, and in some cases the order of the numbers, to win the game based on a predefined payoff schedule. Jackpots may be fixed or progressive.

2. Instant Games

Cardstock of varying sizes is printed with a game and then covered with a polymer which is scratched off to reveal whether the player is a winner. In some cases the entire scratchable area needs to be uncovered to see whether a prize has been won. The card is printed either to be a winner or not and does not depend upon what portions of the card are scratched off.

There are substantial issues with both of these conventional approaches. First of all, in most retail settings with multiple check-out lines where lottery tickets are sold, customers are directed to specific counters or customer service areas where a special machine or dispenser is utilized to create, mark, or verify tickets. The single counter paradigm was often taken to address security issues, or to minimize cost impacts from retailers having to purchase custom lottery dispensing/validation terminals. However, it is difficult to staff this single counter appropriately during high sale volume periods such as evenings, and when there is a large jackpot building for a draw game. In these cases there are often long lines at the single counter to purchase tickets. Players become frustrated and may chose not to purchase a ticket thus resulting in the loss of a sale for the lottery hosting organization and commission for the retailer. Further, customers who do not happen to pass by the customer service counter are not visually reminded of the availability of games, thus opportunities for sales are further lost in large multi-aisle retail settings.

Security of tickets or game cards is vitally important to ensuring the integrity of the games. Specialized registers and software are used to communicate with state and multi-jurisdictional lotteries to ensure those who claim to have picked the winning numbers are making a legitimate claim. Specialized paper and printers are used to create these tickets and discourage counterfeit tickets from surfacing once the winning numbers have been drawn. Due to the cost of the equipment, as well as the nature of the product of the equipment, most retailers have a single counter location for purchasing lottery tickets which includes surveillance cameras and other security equipment.

### SUMMARY OF THE INVENTION

The present invention relates to a system and method for providing an alternative and improved game of chance, and an infrastructure to allow customer-originated purchases of games of chance and recordation and authentication of a bearer instrument. In one embodiment, this invention provides the ability to purchase pre-selected randomly generated numbers for games in any common customer areas or checkout lines at authorized retailers.

Aspects of the present invention improve the previous paradigms of selling draw games by: (a) maintaining security of pre-printed gaming tickets/cards by not allowing such cards to become live (e.g. becoming a bearer instrument) until the ticket is purchased and the cashier activates it; (b) obscuring pre-printed numbers and security codes so they cannot be duplicated until after purchase; and (c) providing customer access to gaming cards can in any desired location such as a check-out line, store end-aisle, aisle cap, or vending machine; thus promoting ease of purchase and reducing bottleneck/crowding problems during peak purchase times.

Additionally, aspects of the invention provide an opportunity for supplementary game experiences for the customer purchasing the gaming instrument by providing a token such as a game card that creates a platform to locate a variety of instant games. Further, aspects of the present invention relate to a novel technique for combing both types of traditional lottery games, draw games and instant games (such as scratch-off card-based games), into a single play experience for the player. Furthermore, a methodology provided by aspects of the present invention allow number selection and delivery to the player in a manner that eliminates the need for player/customer communication access (such as telephone or internet connectivity) to participate in the gaming experience for the player. Additionally, problems associated with the commerce-limiting bottlenecks that result from a customer service counter implementation may be addressed by aspects of this invention whereby a secure method is utilized to “pre-print” and sell numbers for draw games, thus allowing the cards to be sold anywhere in the store and paid for through any check-out line in the store.

This new approach involves creating a card with pre-printed, randomly generated, numbers covered with a “scratch-off” coating and sold in the gift card location of retailer check-out aisles. In aspects of the present invention, the game card may also be referred to as a “Quickcard,” a “Quick Card,” a “Q-Card” or simply a “QC”, and can be sold by authorized lottery retailers in standard check-out lanes, gift card towers, or similar locations. The game card may be created by a third party vendor that may be further responsible for generating, printing, and concealing the random numbers on the cards.

The player selects the specific game card and gives the card to the checkout clerk/cashier who will activate the card upon purchase (similar to any other gift card). The Q card contains one or more rows, (such as five or ten rows) of pre-selected gaming indicia such as random numbers depending upon the game type and card value selected, which have been pre-printed and covered with an opaque scratch-off coating to hide the numbers. The player scratches off the coating to reveal their numbers for the next drawing. An additional feature of the card includes an area where a player can remove the scratch-off coating to reveal an instant prize.

The player's game card is equivalent to any paper ticket a player would receive from a more traditional retail draw-based lottery system, and contains the player's numbers for the next scheduled drawing. Systems of the present invention my not allow additional purchases of gaming cards approximately an hour before any drawing for balancing so that gaming cards would not be able to be purchased during this time period. If a player's numbers match during the drawing that player wins. Once validated after purchase, the Q Card will be the bearer instrument for prize collection and can be redeemed at a retailer or the Lottery office depending upon value.

In one alternative embodiment, one method to provide security is to allow “vouchers” for a ticket to be purchased and the player sends a code over a mobile phone to receive the actual numbers. As a further benefit of aspects of the present invention, the use of the Q Card for purchasing a lottery entry does not require use of a mobile phone, and therefore does not meet the definition of online gambling for certain regulatory or gaming compact purposes.

In one embodiment of the present invention, there is presented a method comprising: presenting a game card for purchase at a merchant location, the game card having an game indicia area obscured by a removable covering; obtaining an activation code from the game card, and thereupon: determining whether the activation code is valid; completing, by the merchant, a purchase transaction corresponding to the game card; and removing the removable covering to reveal game indicia corresponding to entries in a draw game. Game cards may be created in any desired manner, such as by generating a plurality of game entry indicia to form a game board; including the game board within a game indicia area on the game card; associating the game card with a unique serial number; storing the serial number within a database; and obscuring the one or more game boards with an opaque and removable covering.

Various status information may be maintained for game cards, such as may be provided within a database, and in one embodiment may further comprise updating a status for the purchased game card from inactive to active. Also, bonus prizes may be provided, and various embodiments provide for determining, at time of purchase, whether a game card corresponds to a bonus prize, and also, at time of redemption, embodiments may determine whether a game card corresponds to a bonus prize. “Second Chance”-type prizes may be provided as well; various embodiments further comprise determining that the game card did not possess a game board with a winning entry, and offering a second chance game entry for a secondary prize.

Game-related information may be provided to the customer by any desired technique, including printing game information on the game card identifying at least a date corresponding to a draw for the game. Further, game cards may become bearer instruments for redemption upon purchase and verification, obviating the need for having a separate printed or transmitted purchase receipt. Additionally, an instant win indicia may be provided on various embodiments of the game card, corresponding to a predetermined probability of an instant prize being given upon purchase, and an indicia of a winning status may be revealed by the customer removing at least part of the removable covering.

### BRIEF DESCRIPTION OF THE DRAWINGS

A more complete understanding of the present invention may be derived by referring to the detailed description and claims when considered in connection with the following illustrative figures.

FIG. 1 is a line drawing of a game card of the present invention.

FIG. 2 is a reverse side image of the potential card shown in FIG. 1.

FIG. 2A illustrates an alternative implementation of the game card of FIGS. 1 and 2, showing a plan view of both a front and back side of the game card.

FIG. 3 is a block diagram showing aspects of the system of the present invention.

FIG. 4 is a process flow diagram illustrating a purchase of a gaming card of the present invention.

FIG. 5 illustrates a flow diagram of a process of the present invention whereby a game card is validated and redeemed by a customer.

### DETAILED DESCRIPTION OF THE PREFERRED EMBODIMENTS

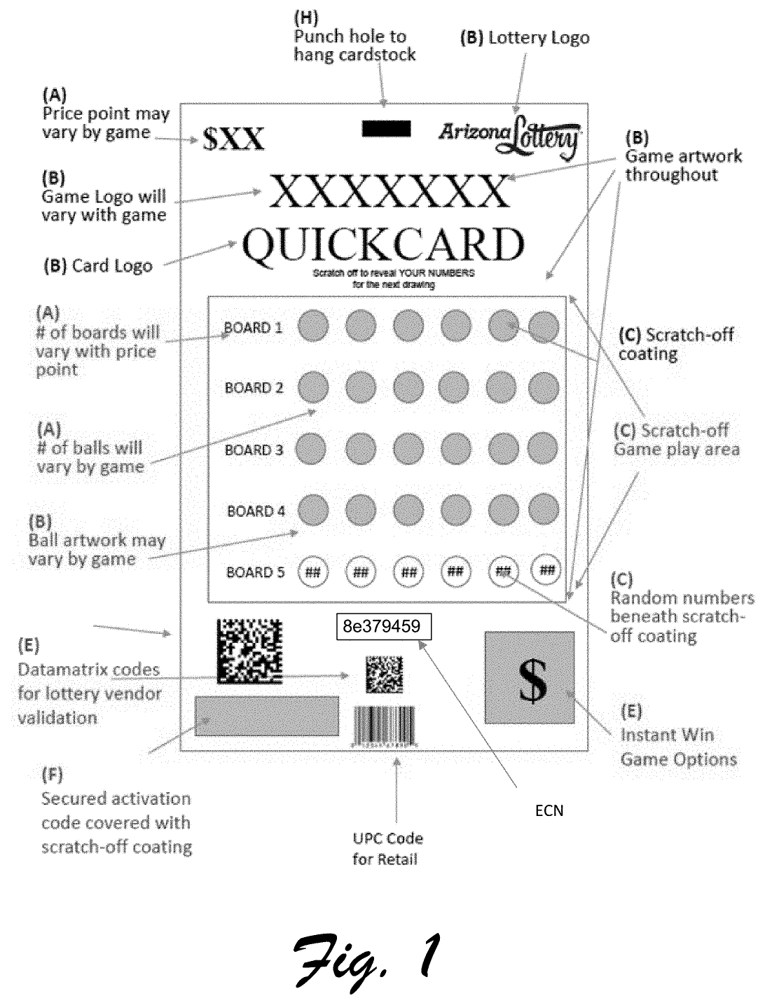

FIG. 1 is a line drawing of the one exemplary game card of the present invention that includes the following special features discussed in more detail below: (A) Multiple price points depending upon the game and the number of play purchased for the game; (B) Visual representation of the game and the card; (C) The play area with random numbers pre-selected and then covered; (D) A “bonus” game play area; (E) Security coding such as a data matrix or QR code that contains unique ID number four gaming card validation; (F) Activation codes for play and potential “second chance” prizes; (G) Retailer UPC codes; and an ECN, or Encrypted Control Number, which is an optional code that is used for additional game card validation by the gaming host agency (or lottery agency). In various embodiments, the ECN may be openly visible, or may be obscured with the scratch-off coating similar to the preselected numbers (C).

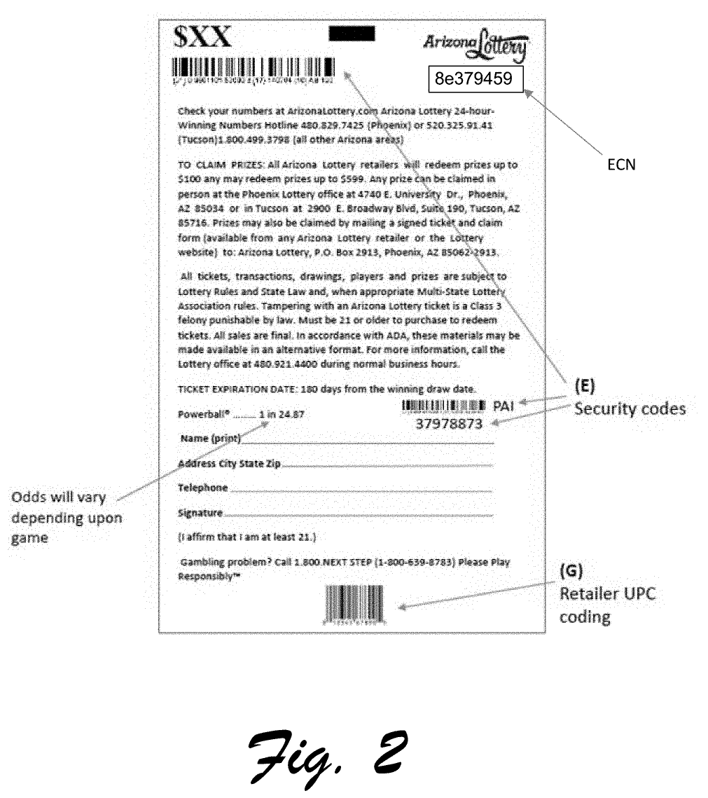

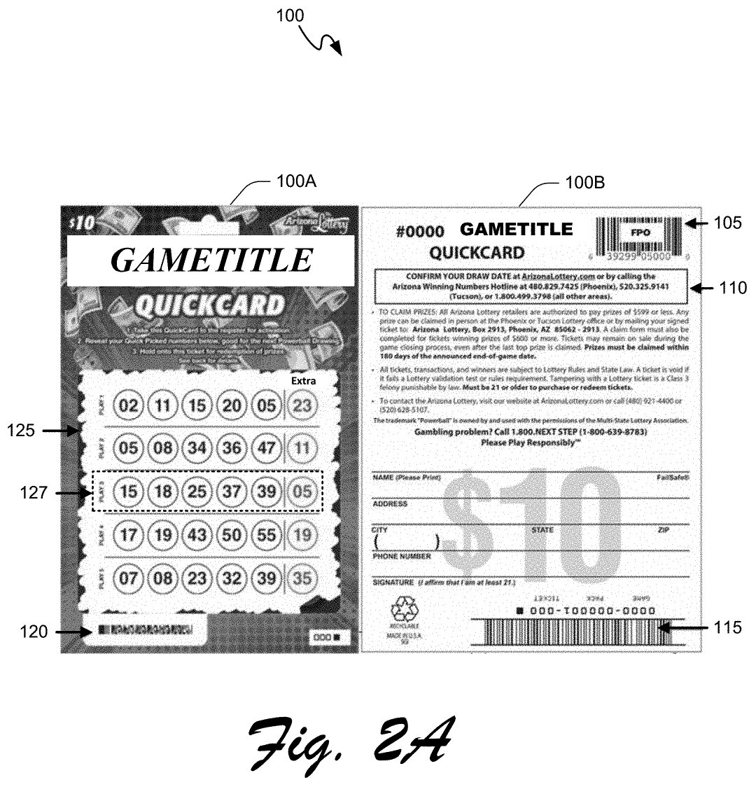

There is provided in various embodiments, a gaming card or game card as illustrated in one implementation in FIGS. 1 (front side) and 2 (reverse side). Those of skill in the relevant arts understand that FIGS. 1 and 2 are provide exemplary layouts for one particular game setup, but more or fewer game numbers may be provided for scratch off, and arrangement and selection of the items shown may be varied on the card for any desired purpose.

Embodiments of the game card (or Quick Card) of the present invention may support any desired type of draw game. Example draw games to be supported include The Pick (from the Arizona Lottery), Pick 3 (from the Arizona Lottery), Fantasy 5 (from the Arizona Lottery), Powerball® and Mega Millions®, along with any other desired draw games.

Referring to FIGS. 1 and 2, specific features are described in detail below by references in parentheses.

### (A)—Multiple Price Points Depending Upon the Game and the Number of Play Purchased for the Game.

The game cards can be sold at multiple price points depending upon the price for each game board (row of pre-selected numbers) and the number of boards per card. This variation allows for future development of games and special pricing, as well as responsiveness to player preferences and data on the number of game boards a player would like to purchase for any given game.

### (B)—Visual Representation of the Game and the Card

Players develop loyalty around specific games. A game card can be developed for any draw game and the identifying marks of the game included on the card as well as the game card name. Artwork throughout the game card will enhance the player experience through increased game branding or special interests such as holidays, sporting events/teams, or other sponsorships.

(C)—The Play Area with Random Numbers Pre-Selected and Covered

Game boards or plays (see, for example, FIG. 2A, dotted box 127 showing Play 3 game board) can be created by any number of random-number generating software packages and pre-printed onto the cards. In various aspects, one aim of the invention is to capture all the pre-selected numbers generated and printed on any specific card and record those numbers into a database associated with a serial number unique to that card. This may prohibit a card from being validated if a player alters numbers revealed on the card after the drawing.

### (D)—A “Bonus” Game Play Area

Players are always looking for the next new experience. The inclusion of an area on the card for instant play opportunities provides a platform for specialization or enhancement of the cards. This area may include, but is not limited to: discounts for the selling retailer; instant prizes such as cash, entertainment, or tangible property; a travel-related prize such as a cruise; multipliers for winning jackpots; or chances for alternative prize drawings. The indication for an instant prize may be provided through any desired method, such as displaying the prize type and a prize value, displaying a price code, or presenting a drawing number that if matched to one of the numbers drawn in the applicable lottery drawing, the customer will win a designated prize. Alternatively, at the point of purchase, when the purchase of the gaming card is verified, an indication may be provided instantly to the cashier indicating that the buyer has won a prize that is redeemable at the merchant or at the gaming host agency redemption office.

### (E)—Security Coding and Potential “Second Chance” Prizes

As mentioned above, coding may be included to capture all the pre-selected numbers generated and printed on any specific card and record those numbers into a data file with a serial number unique to that card. In this embodiment, this represents a serial number and may be used to validate winning cards. The card itself, once purchased and validated, becomes the bearer instrument so in particular embodiments, the game card may not be altered once the game drawing takes place. This unique serial number allows for validation of the numbers on the card after the drawing occurs, as such numbers correspond to the numbers pre-printed on the card before sale and activation. An additional type of game play called “second chance” will use this security coding to confirm a valid entry into secondary prize drawings if a card is not a winning card.

### (F)—Activation Codes for Purchase Validation and Play

A unique activation code number allows the game card to become to “live” when purchased and verified by the uploading of data to a point-of-sale verification service. This provides another security feature to prevent game cards from being stolen by persons that may believe that one of the game cards contains winning numbers. Until a game card is activated using the activation code number, which, in some embodiments will remain covered until the retail clerk exposes it at the time of sale, the card will not be included in the database of game cards that are subject to redemption and payout. Alternative methods may be provided to extract the activation code from the game card through optical scanning techniques, RFID techniques, magnetic stripe reading means, or any method to automate extraction of the unique activation code from the game card.

### (G)—Retailer UPC Codes

The retailer UPC code is a standardized code retailers use to indicate the type of product of being scanned and the appropriate pricing for the product. Unique UPC codes may be assigned to varying game types, and predetermined price point arrangements for particular printed game cards.

(H) Cardstock with Optional Punch Hole

In one preferred embodiment, the game card will be printed on specialized heavy cardstock which will be tested to withstand a variety of methods that may attempt to alter the printed numbers, as well as to see through the scratch off coating. The paper and artwork may also contain specialized watermarks, metallic threads, holographic images, or other methods to prevent counterfeiting. A punch hole may be pressed into the game card to allow hanging in the retailer check-out aisles.

FIG. 2A illustrates an alternate embodiment of a front 100A and back side 100B the game card 100 of the present invention, also known herein as a “Quickcard.” The game card 100 has on at least a front side 100A a scratch-off play area or game indicia area 25 covered with a removable opaque coating (such as latex or any other desired polymer) that a user removes (such as by scratching) to reveal a set of game entry indicia comprising game plays or boards (shown one per line in FIG. 2A, for a total of 5 plays or “boards”, and one of such “boards” is show in dotted line area 127 of FIG. 2A). A retail UPC code 105 may be presented in any desired location, such as a back side 1006 of game card 100. Draw date instructions 110 may also provide purchasers with specific instructions regarding obtaining, confirming, and/or redeeming game winnings. Validation indicia such as a barcode 120 may be present and assist with purchase/enrollment/or redemption in a particular draw or game. Quickcards provide an entry into an on-line game such as a lottery, and in various embodiments, each Quickcard is preprinted with number selections and may have an activation and redemption barcode. In one aspect, an activation barcode 115 may be used to enter the Quickcard into a present open draw for a lottery game. The particular drawing that the Quickcard will be entered into may be, for example, displayed on a point of sale (POS) register, displayed on a website, or may be printed on a player's receipt. Additionally, the same or additional draw-related information may be provided to the player through some other interface such as a web page or SMS message. In one embodiment, the validated Quickcard becomes a bearer instrument and is used to claim winnings using the redemption barcode. Any desired security mechanisms may be employed to validate contest entry or winnings, and may include any number of security codes such as an Encrypted Security Number (ECN). The ECN Security Key and redemption barcode, in one embodiment, may be printed on the game card in an area covered by an opaque scratch-off coating and in one aspects, are not sent in the transaction processing when activating a game card purchased from a retailer.

A third party processor, in one embodiment, may create and maintain a database containing activation codes and play data related to a collection of Quickcards intended for sale, and may deliver data from the database or otherwise provide access to the database to a print vendor. Such print vendor may add a redemption code and security information to the database and may retain that database. In one embodiment, the ECN mentioned above is generated and printed on the card by the print vendor but may not be stored for any particular point in time, and may not be stored beyond the printing process. In one further aspect, if a reconstruction of ECN numbers or printed game cards is necessary, a request must be submitted to the print vendor.

### Process for Purchase and Redemption.

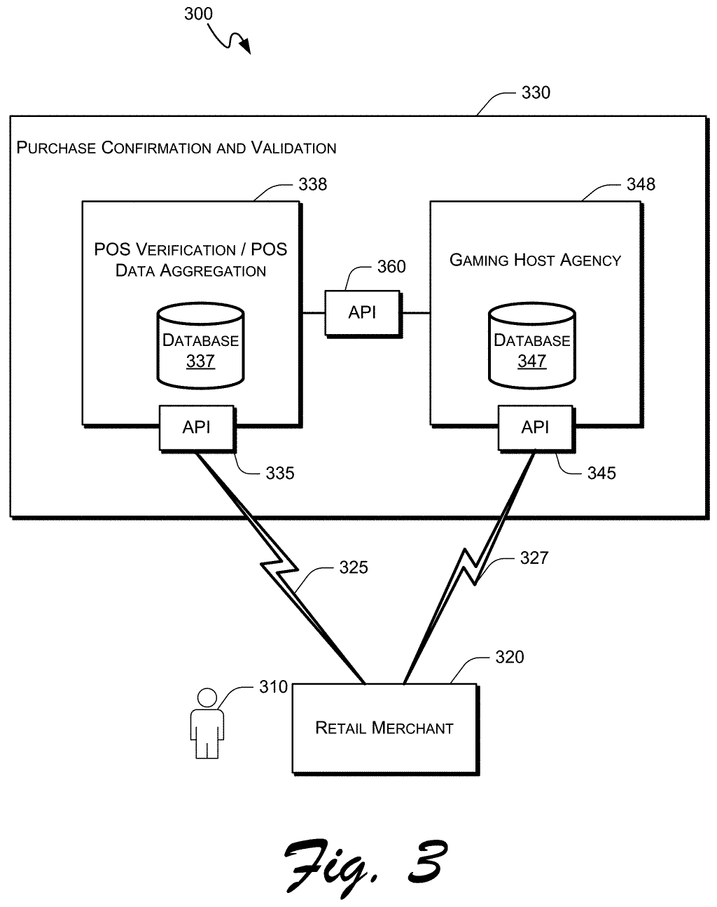

FIG. 3 illustrates a system 300 of the present invention. The system 300 includes a retail merchant 320 that is communicatively coupled 325, 327 (such as through a network connection, a wireless connection, or a computer network connection such as provided by the Internet) to a purchase confirmation and validation system 330. The purchase confirmation and validation system 330 includes a point-of-sale verification and data aggregation function 338, a gaming host agency 348, and APIs 335, 360, 345 providing for transfer of data between the retail merchant 320, and the purchase confirmation and validation system 330. Those of skill in the art understand that the point-of-sale verification and data aggregation function 338 and the gaming host agency 348 may be one in the same entity, or separate entities as illustrated.

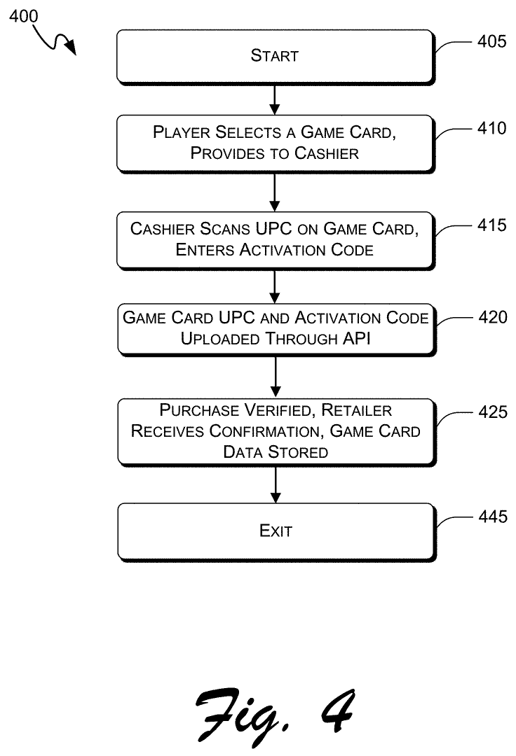

Referring to FIG. 4, a process is provided to purchase a game card of the present invention. Referring also to FIG. 3, customer 310 enters retail merchant 320 and selects 410 a game card such as illustrated in FIGS. 1 and 2, and provides the game card to the cashier of the retail merchant 320. The cashier of the merchant 320 scans 415 a UPC code of the game card, and obtains an activation code from the game card through a process such as scratching off a removable covering over a preprinted activation code. In alternate embodiments, the activation code may be obtained by scanning a second barcode on the game card, scanning and encrypted QR code, reading an RFID code embedded within the game card, reading of magnetic area disposed upon the game card, or any other automated means to extract an activation code from the game card. Once the cashier of the merchant 320 obtains the activation code, it is entered or provided 415 and uploaded 420 through the communications link 325 and API 335 to the point-of-sale verification and data aggregation service 338. The service 338 receives the UPC code corresponding to the game card along with the unique activation code obtained in step 415, and confirms the validity of the activation code within database 337, such as by verifying that the activation code is valid, and has not expired or otherwise been attributed to an already-sold game card. Once the game card data comprising UPC code and activation code has been verified, confirmation of validation is provided through API 335 and communications link 325 to the merchant 320, allowing the merchant to complete the transaction and sale of the game card to the customer 310, and to provide the verified and enrolled game card back to the customer. In one optional embodiment, the game card may be placed in a printing device such as a check endorsing device that places upon the game card information such as the date, time, and location where the card was purchased, along with any other information to assist with verification for any later redemption purposes. In yet another embodiment, verification information may be stored in a medium within the game card, such as a magnetic stripe, or within nonvolatile memory of an RFID/NFC-operated device. After the sale and verification is complete or any time thereafter, the customer may scratch off or otherwise remove the coating (C) on the game card to reveal the randomly assigned numbers on the game card that may be selected in the next lottery drawing. Also at this time, verification and data aggregation service 338 provides the activation code and any associated game card data obtained from database 337 through API 362 gaming host agency 348, where it is stored in database 347. At this point in time, the gaming card purchased by the customer 310 is a bearer instrument and may be used to redeem potential winnings from the next scheduled drawing.

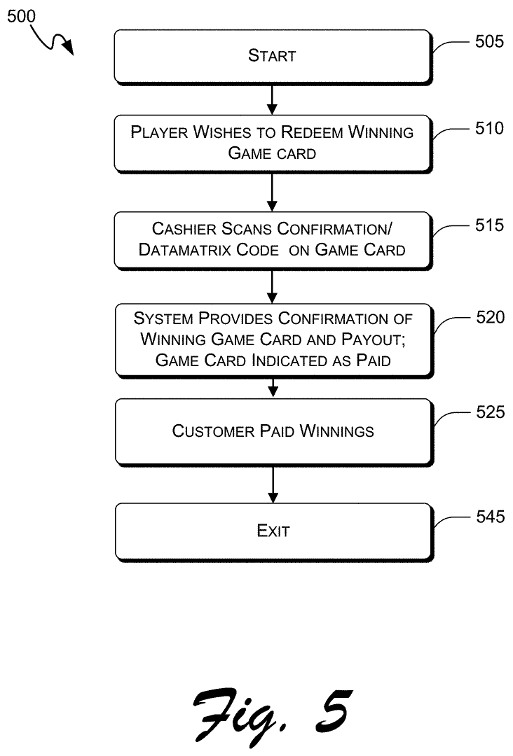

FIG. 5 illustrates one embodiment of redemption process 500 of a game card of the present invention. Once the customer 310 has removed the scratch off coating see from the game card, the customer can compare the preselected numbers on the game card to number selected in the next scheduled lottery draw game. If the customer identifies a winning combination, the customer 310 may submit the game card for redemption and payout of any associated prizes. The customer 310 approaches a retail merchant 320 or a gaming host agency 348 to begin 510 the redemption process for a winning game card. Depending on the rules of the particular lottery, the prize amount may determine whether the customer can redeem a winning game card at a retail merchant 320, or whether the customer must redeem the winning game card at a gaming host agency 348. Once at the redeeming entity, the customer 310 presents the bearer instrument, which is the purportedly winning game card, and information from the game card is scanned 515 and uploaded 327 through API 345 to the gaming host agency. The code number obtained from the game card may be the same or different number than the activation code previously mentioned, or may constitute the ECN, or number encoded within the data matrix (E), or within any other encoding or visual indicia on the game card. The gaming host agency 348 uses the information obtained through the API 345 to determine whether a verified gaming card reference exists within database 347. Upon verification of the authenticity of the uploaded and stored information associated with the game card, the gaming host agency 348 provides confirmation of the winning game card and the amount of payout, and the database 347 is updated to indicate payout has been performed (thus avoiding potential double payouts). Once the confirmation is transmitted 327 to the retail merchant where the customer 310 is attempting redemption, or at the gaming host agency office 348 where the customer may be attempting redemption, the customer 310 is paid 525 the appropriate amount of winnings based on the game outcome for the game card.

In yet another embodiment of the present invention, customers 310 are presented with the opportunity to download and install an app on their mobile devices. Such apps are configured to interface with the gaming host agency 348 in a manner that allows the client to implement a virtual play slip. In prior methods, customers wishing to select specific lottery numbers would use a marker and a piece of paper (or play slip) to make selections of numbers so that the clerk selling a particular lottery ticket may enter the customer's selected numbers as entries into the play ticket. In various embodiments a mobile device configured with the app as described above, and will allow the user 310 to make selections of a particular game, payout, and number selections. The app will verify the entries, upload the user-input data to the database 347, and provide to the cashier completing the transaction an information element or code to complete the purchase. In one embodiment, once the customer's information is entered and verified by the gaming host agency 348, the app on the user's mobile device may display a scannable code such as a QR code that may be scanned by the cashier selling the lottery entry. In such a way play slips are replaced with a mobile device, and less opportunity for error exists as the user is entering desired play numbers directly into their own mobile device.

Those of skill in the art may recognize that that while gaming cards such as QuickCards (QC, also known as Quickcards or Quick Cards) are herein described, various embodiments of the concepts presented herein will work for conventional player selected or quick pick entries at a point of sale (POS) lottery terminal. Further, in one alternative embodiment, one method to provide security is to allow “vouchers” for a ticket to be purchased and the player sends a code over a mobile phone to receive the actual numbers.

Instant Win Options

Various embodiments provide for instant win options for pre-printed game cards. For example, purchase of the game card could include an instant win with a predetermined (and advertised) probability. There may be various indicia pre-printed on the game card such as “One in 10 cards automatically wins!,” or “Instant Winner Bonus—1 in 10 Cards Wins!” or “Instant Win Bonus—A Free Bonus Quick Card for Lucky Winners.” The instant win reward could be provided to the customer at time of purchase, or could be only payable after the next regular drawing, so that both are paid at once if warranted.

In one embodiment for an instant win option, the option has a predetermined probability, and purchase of a card may be free or reduced cost to the customer if the particular card has a winning instant option, or discounts may be provided to customers for their entire purchase order at the retail store where the game card was purchased, or an additional free game card may be provided to the customer if the game card reveals a winning indicia. In various embodiments, instant win may be provided by a display to the merchant or the customer, or, alternatively, an instant win may be identified by scratch off or removing an opaque coating from the game card, thus helping to prevent avoid fraud or other customer tampering or defacement. Instant wins, in various embodiments may also be computed at time of purchase, with a remote validation database determining whether the purchased game card is a winner. This could be accomplished through a previously populated database of instant wins, or could be determined through a random number generator on a real-time basis.

While in preferred embodiments game indicia or game boards are predetermined and pre-printed on the game cards, various embodiments also provide for user-selected inputs of numbers. For example, a customer may scratch-off a matrix of numbers pre-printed on a card, then the card is scanned and the scratched-off numbers are identified by the lottery system as the customer's selected numbers. In one embodiment, the card is scanned optically to determine which numbers were selected, and pre-selected optical contrast between the removable opaque covering and the underlying printed card numbers enables the scanning system to determine the selected numbers. To verify selection, the customer may review information, a receipt, or a card printed receipt after purchase, and/or and when selected numbers are displayed on POS, the customer enters yes or no for purchase.

Multiple Drawings

In one embodiment, a game card may be reused in multiple drawings. In various embodiments, for example, since a unique ID/serial number is associated with each game card that can be used for tracking purposes, upon purchase, this unique ID may be is stored in a database during the validation process along with the purchase information, and later re-used in a multiple game scenario.

In one embodiment, a Point of Sale (POS) method may be used to provide for multiple game play. For example, at time of initial sale, the customer may be prompted to enter multiple drawings, and the customer may select an option by one of informing the merchant, selecting a desired number of drawings on a merchant or vendor terminal, purchasing a multi-game game card, purchasing a card indicating a game multiplier, or any other desired approach. The customer may specify how many game boards desired and for how many drawings, the merchant/cashier enters the selected data, the customer remits appropriate payment, and the game card, along with the desired number of draws is entered in the specified number of drawings. Also, in one variant, the merchant/cashier may re-scan the same game card, and the cash register/entry terminal prompts whether the customer is desiring to enter into an additional drawing with the same game board number, and after a dialog with the customer, one or more additional are entered into the system for purchase. In various embodiments, all of the POS data is captured, transmitted, and validated, creating a bearer instrument for the desired number of games. A receipt can be emailed or sent to the customer in addition to a printed receipt, or other preferred embodiments, the game card may be updated with relevant game-related information.

In another embodiment, a user may utilize a post-purchase online multi-game entry. In this implementation, the customer may create an account for the hosting lottery including secure customer ID/password; then the customer may “enroll” one or more game cards in the customer's account using each game card's unique ID. Verification is performed to ensure the unique ID corresponds to a valid and purchased game ticket that is qualified for the next draw. In one variant, a game card that has been previously purchased by the customer may be reactivated for new draws. The online interface also may provide for convenience tracking of the next draw date/time, winning numbers, whether the card won, etc.

Various options for multi-game entry and management are presented to the customer through a graphical customer interface. If the customer wishes to purchase additional entries into future drawings for one of the customer's enrolled QCs, there are various options available:

(a) submit payment online, where confirmation will be sent to the customer and logged in the customer's account.

(b) transmit a token to the customer's mobile device for completion at a valid merchant POS location; such token may be a barcode or QR code that displays on the customer's mobile device, is scanned by the cashier at the POS location, and then the customer remits payment (such as in situations where cash is the only allowed mode of tender). The transaction may then be logged through the POS data capture, transmitted to the remote validation database, and the record for the QC is updated to enable multi-draw operation for the desired number of drawings.

(c) the customer could also print a barcode/QR code from the customer's online account for scanning by a cashier at POS if the customer does not want to use a mobile device to complete purchase at a later time.

(d) remote transmission to vendor: in one implementation, a request to purchase multiple games for a game card is sent to a merchant's online account and associated with the customer's customer ID and the game card's unique ID; when the customer goes into the merchant location, the customer may present their customer ID and identifying information to allow completion of the purchase.

Parlay—Multiple Event Matching with Enhanced Payout

Parlays provide alternative betting options to allow for enhanced payouts and additional play opportunities for customers. In one embodiment, enhanced payouts may be offered for multiple rounds of traditional lottery draws, and may be integrated with a game card offering embodiment as utilized in the present invention. Depending on the number and type of parlays, because of the reduced odds of winning, enhanced payout schedules could theoretically compete with the multistate games' very large jackpot offerings (e.g. hundreds of millions) and generate player excitement without the player having to wait for a huge jackpot to accrue.

In various embodiments, the customer may select how many parlay draw rounds are selected. In the simplest version, one game card's number configuration is re-used over a customer-specified number of parlay draw rounds, and if each is a winner, the customer wins a highly enhanced payout. In one embodiment, such reuse could be offered as a “freemium” for regular cards to promote enhanced sales of game cards (e.g., a game card could advertise a three-game parlay that activates upon customer purchase of the game card, where three numbers must be matched each time, and if so, payout is a computed amount.)

The number and type of matched events in various parlay embodiments may vary; for example, embodiments may offer modified winning criteria for each round of the drawing requiring fewer matches for a “winning” round (e.g. only two matched numbers to be considered a winning parlay entry); however, in various embodiments, like in a other traditional parlay bets, multiple winning rounds are required for a payout, and a payout schedule offers enhanced payouts based on the more difficult winning criteria.

Different payout schedules may be created for winning rounds with a selected token (e.g. one payout may be made if a Powerball® was not matched, but a much higher one would be paid out if a winning Powerball® was drawn on a parlay round). Further, various embodiments may provide for a “step down” consolation schedule for reduced payouts if not all draws are winners; for example, in one embodiment, if four out of 5 drawings had winning bet criteria, the customer may be offered a drastically reduced payout (i.e. not all five had to win, as in traditional parlay plays).

Another embodiment utilizes “Round Robin” parlay betting Offer Round Robin draws for multiple tickets, or in various aspects, multiple entries in one draw. For example, multiple quick card IDs may be associated like the “sports teams” in a parlay draw system; a customer chooses may choose how many draws (team cards) are to be grouped in each parlay; an amount to be paid is computed and sent to merchant for completion of payment; databases updated to enter possible parlay payouts for customer, and optionally, the customer may be informed via text/email/call when parlays are found to reach a payout threshold. As an alternative, rather than individual game card entries being grouped together in round robin parlays, the customer may select a group of playable numbers, (e.g. five numbers, for example) and must achieve multiple wins in games where a predetermined subset of those are drawn (e.g., three out of the five numbers must be drawn over each the customer's six parlay draw rounds). If the winning criteria is met, the customer's payout is credited to the database, and the customer may redeem.

In another variant of parlay play, embodiments provide for multi-game parlay from single game card. In one variant, one player's game card entry is stored for parlay over multiple rounds; for example, the customer may choose a parlay of five drawings where three numbers have to be drawn from the player's stored numbers each drawing; if this occurs, a payout is provided according to a published schedule. In various embodiments, multiple levels and kinds of parlays may thus be offered, creating an array of player options, with potentially very large payouts (and thus spurring player interest).

As mentioned previously multiple game rounds and/or second chance games may be implemented as desired; for example, the customer may appear in person at the point of sale, the customer's game card may be scanned by the merchant or at a terminal, the customer remits funds for a desired number of replays, and then confirmation entered into merchant and system databases for future scheduled draws. In various embodiments, the customer may authorize, such as through a mobile app, a specified initial merchant to re-bill method of payment, and additional rounds of play may be purchased. Further, in multiple game embodiments, a unique ID can be associated with a desired number of future games (e.g. 10 games), and at the merchant, point of sale, or terminal, the customer tenders funding and databases are correspondingly updated to authorize potential payouts for the selected numbers corresponding to the unique ID on the selected dates.

One embodiment provides for a “Let it Ride” aspect. In this implementation, the customer may select an option to allow winnings to automatically be re-invested in purchase of another draw round. In one aspect, the customer may terminate the option by a predetermined date, and may redeem the ticket for the last-invested winnings; alternatively, the customer may request generation of random quick pick numbers for the additional rounds, or do so in part (e.g. the customer may select the game card unique ID for one or more of the future draws and a randomly generated draw entry for the remaining winning funds that are reinvested).

Additionally, as an additional parlay option, customers may select from multiple types of lottery draws as part of a parlay-type entry. In one aspect, a game card is entered in multiple drawings as a bundle, and if the customer wins on multiple of the lottery game types, a parlay payout becomes available (e.g. if the customer is lucky enough to win both Powerball® AND Mega Millions® in one week, the customer could win a very large amount such as one billion dollars.)

There are also various bundling options provided in embodiments of the present invention. When referring to “bundling,” various types, kinds, and numbers of draws may be collected together and associate with the customer's game card. For example, a bundling option may allow purchase and tracking of multiple games, both in-state and multistate. Further options may include: a daily draw bundle or a weekly draw bundle, where, for instance the customer selects the maximum number of available weekly draws and purchase them all (and as part of purchase, now become associated with the customer's game card unique ID). The customer may also specify number of draws for the week, and number of repeats for each game. Further, in other bundling options, the customer may select multiple in-state lottery games to be bundled. Bundling may be managed by any desired technique, such as customer interaction with a merchant or merchant terminal, through a mobile app, online purchase, or through purchase of a game card a t a point of sale that is custom-configured as a bundle purchase (e.g. one game card could present a MULTI-PICK CARD option whereby purchase will enter the customer automatically in the next regularly scheduled Arizona Pick, Powerball, Fantasy 5, Mega Millions, and any other lottery available within the Customer's geographic region.)

The present technology may be described in terms of functional block components and various processing steps. Such functional blocks may be realized by any number of hardware or software components configured to perform the specified functions and achieve the various results. For example, the present technology may employ systems, technologies, devices, algorithms, designs, services, and the like, which may carry out a variety of functions. In addition, the present technology may be practiced in conjunction with any number of hardware and software applications and environments. The system described is merely one exemplary application for the invention.

Systems and methods describing various aspects of the present system may operate in conjunction with any suitable computing process or device, interactive system, input system or method, output system or method, and/or telecommunication network. Various representative implementations of the present technology may be applied to any computing device or application configured to communicate via a telecommunication network or wired communication protocol. Certain representative implementations may comprise, for example, program code stored on any combination of computing devices. Various representative algorithms may be implemented with any combination of data structures, objects, processes, routines, other programming elements, and computing components and/or devices.

The present technology may involve multiple programs, functions, computing devices (such as a mobile communication device, a home network, or network-accessible client computers and/or servers, a cellular network), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or presenting content, interfacing a computing device to a network, transmitting and/or receiving data, providing a user interface, communicating information, interfacing with a user, detecting and/or analyzing input to a computing device, gathering data, tracking environmental parameters, collecting and managing user accounts and information, calculating statistics and environmental loading effects, and the like.

A computing device may comprise conventional components, such as a processor, a local memory such as RAM, non-volatile memory such as FLASH memory, long term memory such as a hard disk, a network adaptor, and any number of input and/or output devices such as a keyboard, mouse, monitor, touch screen, microphone, speaker, motion sensor, orientation sensor, infrared sensor, RFID/NFC sensor, electrical current sensor, light sensor, and the like. The various memories of the computing device may facilitate the storage of one or more computer instructions, such as a software routine and/or software program, which may be executable by the processor to perform the methods of the invention. A computing device may comprise an embedded processor in such as a comfort management control device, a personal computer, a server, a mobile phone, a smart phone, a tablet computer, a kiosk, a portable computer, a vehicle-embedded computer, and the like. Further, the databases, systems, and/or components of the present technology may include any combination of databases, systems, and/or components at a single location or at multiple locations. Each database, system, and/or component of the present technology may comprise any suitable security features, such as firewalls, access codes, encryption, de-encryption, compression, decompression, and the like.

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a computer program product on a computer-readable storage medium having computer-readable program code embodied in the storage medium in a non-transitory manner. Any suitable computer-readable storage medium may be utilized, including any combination of hard disks, CD-ROM, FLASH memory, optical storage devices, magnetic storage devices, USB memory devices, any appropriate volatile or non-volatile memory system, and the like. The present technology may take the form of a downloadable and/or cloud-based non-downloadable computer program product and/or methods.

Software and/or software elements according to various aspects of the present technology may be implemented with any programming, scripting, or computer language or standard, such as, for example, AJAX, C, C++, Java, JavaScript, COBOL, assembly, PERL, Python, Ruby, eXtensible Markup Language (XML), PHP, CSS, etc., or any other programming and/or scripting language, whether now known or later developed. Further, the present technology may be used in conjunction with a computing device running any operating system such as any version of Windows, MacOS, OS/2, BeOS, Linux, UNIX, Android, iOS, or any other operating system, whether now known or later developed.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

As used herein, the term “mobile device,” “mobile electronic device,” or “device” generally refers to any electronic device capable of being moved from place to place, and may be a stand-alone device such as a laptop computer, a desktop computer, a mobile subscriber communication device, a mobile phone, a personal digital assistant (PDA), a data tablet, a digital camera, a video camera, a video game console, a media player, a global positioning system (GPS), Universal Serial Bus (USB) keys, mobile weapons, smart watches or jewelry, embedded electronics, automobile communication interfaces, and combinations thereof. A mobile electronic device may also be any electronic device integrated with another system or device. For example, a stereo, global positioning system, or other electronic device contained within a vehicle may be utilized in concert with the present invention. Software to implement methods of the present invention can be (1) installed on, or (2) downloaded onto a mobile device indirectly or directly at any time by an authorized user through the Internet, SMS text message, through wireless communication with an app provisioning store, or in any other suitable manner and at any suitable time for carrying out a method according to the invention.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A method comprising:
presenting a game card for purchase at a merchant location, the game card having an game indicia area obscured by a removable covering;
obtaining an activation code from the game card, and thereupon:
determining whether the activation code is valid;
completing, by the merchant, a purchase transaction corresponding to the game card; and
removing the removable covering to reveal game indicia corresponding to entries in a draw game.

2. The method of claim 1, further comprising:
generating a plurality of game entry indicia to form a game board;
including the game board within a game indicia area on the game card;
associating the game card with a unique serial number;
storing the serial number within a database; and
obscuring the one or more game boards with an opaque and removable covering.

3. The method of claim 1, further comprising updating a status for the purchased game card from inactive to active.

4. The method of claim 1, further comprising determining, at time of purchase, whether a game card corresponds to a bonus prize.

5. The method of claim 1, further comprising, determining, at time of redemption, whether a game card corresponds to a bonus prize

6. The method of claim 1, further comprising, determining that the game card did not possess a game board with a winning entry, and offering a second chance game entry for a secondary prize.

7. The method of claim 1, further comprising printing game information on the card identifying at least a date corresponding to a draw for the game.

8. The method of claim 1, wherein the purchased game card becomes a bearer instrument for redemption upon purchase and verification.

9. The method of claim 1, further providing an instant win indicia on the game card, corresponding to a predetermined probability of an instant prize being given upon purchase.

10. The method of claim 9, wherein an indicia of a winning status is revealed by the customer removing at least part of the removable covering.
